(19) United States
(12) Patent Application Publication
(10) Pub. No.: US 2018/0111616 A1
(43) Pub. Date: Apr. 26, 2018

(54) TARGET SPEED CONTROL SYSTEM WHICH USES ACCELERATION AND BRAKE PEDALS

(71) Applicant: NextEV USA, Inc., San Jose, CA (US)

(72) Inventor: Robert Herb, Morgan Hill, CA (US)

(73) Assignee: NextEV USA, Inc., San Jose, CA (US)

(21) Appl. No.: 15/640,326

(22) Filed: Jun. 30, 2017

Related U.S. Application Data
(60) Provisional application No. 62/412,517, filed on Oct. 25, 2016.

(51) Int. Cl. B60W 30/14; B60W 10/04; B60W 10/18

(52) U.S. Cl. CPC B60W 30/143; B60W 10/04; B60W 10/18; B60W 2540/10; B60W 2540/12; B60W 2710/083; B60W 2720/10; B60W 2710/09; B60W 2710/18; B60W 2710/0666; B60W 2520/10

(57) ABSTRACT

A speed control system includes features which allow for control of a target speed through use of an acceleration pedal and a brake pedal. The control system includes a drivetrain, a braking system, and a plurality of traction devices configured to accelerate and decelerate the vehicle based on input from the drivetrain and braking system. The control system further includes the acceleration pedal and brake pedal configured to be operated by a driver. The control system also includes a controller and one or more sensors. The controller is electronically connected to the drivetrain, the braking system, the acceleration pedal, the brake pedal, and the one or more sensors. The controller is configured to store a target speed and adjust the target speed based on input from the acceleration pedal, the brake pedal, and the one or more sensors.

### CROSS REFERENCE TO RELATED APPLICATIONS

This application claims the benefit of U.S. Provisional Patent Application No. 62/412,517, filed Oct. 25, 2016, which is incorporated by reference as if fully set forth herein.

### FIELD OF INVENTION

The present disclosure is directed to a vehicle control system, and, more particularly, to target speed control through the use of the acceleration and brake pedals.

### BACKGROUND

In an electric vehicle, internal combustion engine (ICE) vehicle or hybrid vehicle, the acceleration pedal in conventional implementations controls the acceleration torque applied to the powertrain and the brake pedal controls the deceleration torque. One of the problems associated with this behavior is that long drives are very tiring because the driver needs to constantly keep the acceleration pedal pressed.

Using cruise control in combination with changing target speeds helps, but is not very intuitive. In order to change the target speed (e.g., due to change of speed limit), the driver usually must hold the cruise controller stalk up or down. This is a slow process. In order to match changing traffic and road conditions, the driver must use the cruise control stalk or reset the target speed constantly. Alternatively, the driver may cancel cruise control, change speed through the use of the pedals, and then reset cruise control, which is not ideal, especially when many speed changes are necessary. Both of these potential solutions require a user to make changes using their hands to operate the cruise control input controls. This may be cumbersome and distracting to the driver. The present disclosure is directed to overcoming these and other problems.

### SUMMARY

The present disclosure is directed to a control system. The control system includes a drivetrain, a braking system, and a plurality of traction devices configured to accelerate and decelerate the vehicle based on input from the drivetrain and braking system. The control system further includes the acceleration pedal and brake pedal configured to be operated by a driver. The control system also includes a controller and one or more sensors configured to generate a signal indicative of a parameter of the vehicle. The controller is electronically connected to the drivetrain, the braking system, the acceleration pedal, the brake pedal, and the one or more sensors. The controller is configured to store a target speed and adjust the target speed based on input from the acceleration pedal, the brake pedal, and the one or more sensors.

In another aspect, the present disclosure is directed to a method of controlling a speed of a vehicle. The method includes storing a target speed of the vehicle in the controller based on the depression of the acceleration pedal or the brake pedal and an output of the speed sensor. The method also includes maintaining the vehicle at the target speed via the controller by applying a torque to the traction devices using the drivetrain and the braking system. The controller may determine the target speed based on the output of the speed sensor at the time of the acceleration pedal or brake pedal being released. Alternatively, the controller may continuously updated the target speed based on the position of the acceleration pedal or brake pedal while depressed and simultaneously match the vehicle speed to the target speed using the drivetrain, braking system, and speed sensor.

### BRIEF DESCRIPTION OF THE DRAWINGS

The foregoing Summary and the following detailed description will be better understood when read in conjunction with the appended drawings, which illustrate a preferred embodiment of the invention. In the drawings:

FIG. 1 is a schematic drawing of a vehicle, according to an embodiment.

FIG. 2 is a schematic illustration of an acceleration pedal.

FIG. 3 is a schematic illustration of a brake pedal.

FIG. 4 is a flowchart of a method for target speed control using the acceleration and brake pedals.

### DETAILED DESCRIPTION

The present disclosure is directed to a vehicle acceleration and speed control system in which the acceleration pedal controls the acceleration of the vehicle, the brake pedal controls the deceleration of the vehicle, much like a conventional design. However, in addition to these conventional controls, if the acceleration pedal is released, the vehicle maintains the current speed. It does not coast or decelerate driving uphill, it does not accelerate going downhill. In addition or alternatively, if the brake pedal is released, the vehicle also maintains the current speed. The vehicle does not coast or decelerate driving uphill, it does not accelerate going downhill.

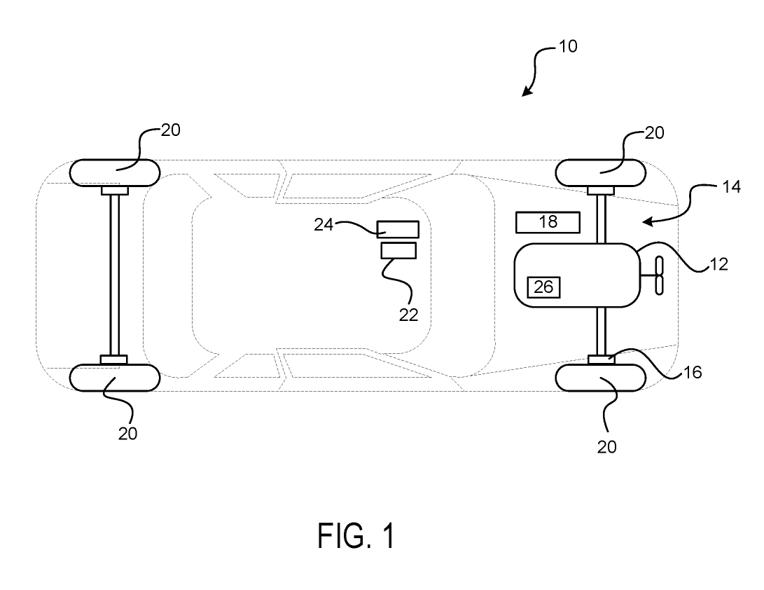

FIG. 1 illustrates an exemplary vehicle 10. In an exemplary embodiment, the vehicle 10 includes a drivetrain 12 consisting of an electric motor, an ICE or a combination of both, a traction system 14, a brake system 16, and a controller 18. The traction system 14 may include wheels and tires 20. The drivetrain 12 may be operatively connected to an acceleration pedal 22 and a brake pedal 24. The acceleration pedal 22 is operable to accelerate the vehicle 10 (e.g., via the drivetrain 12 and traction system 14). The brake pedal 24 is operable to slow the vehicle (e.g., via the drivetrain 12 and/or brake system 16). The acceleration pedal 22 and brake pedal 24 are preferably in a conventional position inside the passenger compartment of the vehicle and operable by the feet of a driver. Alternative embodiments and configurations of the pedals are possible, however.

The controller 18 may be configured as a microcontroller, computer, processor, etc. which is electronically connected to the drivetrain 12, brake system 16, acceleration pedal 22, and brake pedal 24. The controller 18 may be further connected to one or more sensors 26 configured to measure a parameter associated with the vehicle or a component of the vehicle. For example, the controller 18 may be electronically connected to a speed sensor configured to measure a speed of the vehicle 10 and/or an acceleration sensor configured to measure an acceleration (or deceleration) of the vehicle 10. The controller 18 is configured to implement acceleration control based on signals received from the acceleration pedal 22, brake pedal 24, and/or one or more sensors 26.

In a conventional scheme, the acceleration pedal 22 may be depressed in order to cause the drivetrain 12 to generate torque to accelerate the vehicle 10. This may include the driver periodically depressing the acceleration pedal 22 to maintain a particular speed or speed range. In order to slow the vehicle 10, the driver would normally depress the brake pedal 24, creating friction within the traction system 14 and causing the vehicle 10 to decelerate. After the acceleration pedal 22 is released, the vehicle 10 begins to coast and decelerates due to friction and the lack of torque input from the drivetrain 12. After the brake pedal 24 is released, the additional braking torque is removed and the vehicle 10 decelerates at a slower pace or is allowed to move at an idling speed. The lack of braking torque also allows gravity to accelerate the vehicle (e.g., up or down a hill).

Many vehicles include a cruise control function which allows the controller 18 of the vehicle 10 to automatically monitor and control the acceleration and deceleration of the vehicle 10 in order to maintain a selected speed. Typically, the driver could set the selected speed using a control mechanism on the steering wheel or dashboard, such as one or more control buttons or stalks. This system becomes impractical for changing speeds multiple times over a short period of time, which may be necessary in some circumstances (e.g., when navigating through traffic). The below embodiment of the present disclosure includes an improved configuration for controlling the speed of a vehicle, such as electric vehicle, ICE vehicle or hybrid vehicle 10.

In an exemplary embodiment, when an acceleration pedal 22 is depressed, the vehicle 10 accelerates (e.g., the controller 18 commands the drivetrain 12 to generate torque). When the acceleration pedal 22 is released and returns to the zero (e.g., undepressed) position, the controller 18 controls the systems of the vehicle 10 to maintain the vehicle speed. When the acceleration pedal 22 is depressed again, this may cause the drivetrain 12 to produce additional torque. For example, the drivetrain 12 may be applying torque to maintain a current target speed and then be commanded by the controller 18 to provide additional torque to accelerate the vehicle past the target speed, based on input from the acceleration pedal 22. The brake pedal 24 may similarly be used to provide braking torque to slow the vehicle to a new target speed when a previous target speed is being maintained.

For example, the controller 18 may determine a vehicle speed at a time that the acceleration pedal 22 returns to zero (e.g., via sensor(s) 26), store this speed as the current target speed, and command the drivetrain 12 to provide enough torque to maintain the speed (i.e., overcome the slowing of the car due to drag or going uphill) or may command the drivetrain 12 and/or brake system 16 to provide enough deceleration to maintain the speed (i.e., to overcome the acceleration of the car due to gravity when going downhill or some other force). In this way, the acceleration pedal 22 may be used as an input device to set a target speed.

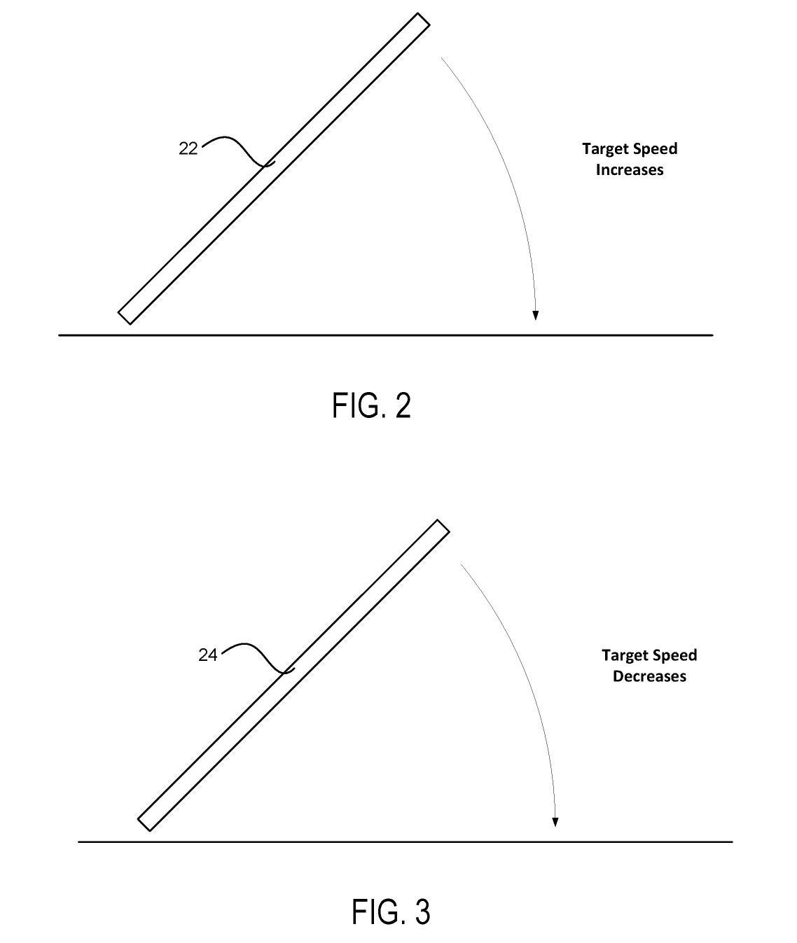

FIG. 2 is a schematic illustration which includes the acceleration pedal 22 in the zero, undepressed position. As the driver presses on the acceleration pedal 22, the vehicle accelerates and, as a result, target speed increases. This target speed may be initially set to 0. As the acceleration pedal 22 is depressed, this target speed may increase as the speed of the vehicle 10 increases. When the acceleration pedal is released, the controller 18 determines the current speed and stores this as the current target speed. In this way, the driver may operate the acceleration pedal 22 to accelerate the vehicle 10 as usual, with the resulting speed of the vehicle when the acceleration pedal 22 is released being a target speed for being maintained by the controller 18.

The controller 18 may be similarly configured to control speed based on input from the brake pedal 24. When the brake pedal 24 is depressed, the drivetrain 12 and/or brake system 16 may slow the vehicle (either directly or indirectly through input from the controller 18). When the brake pedal 24 is released, and returns to the zero (e.g., undepressed) position, the controller 18 may determine the current speed of the vehicle (e.g., via the sensor(s) 26), store this speed as the current target speed, and control the systems of the vehicle 10 to maintain this target vehicle speed. For example, the controller 18 may command the drivetrain 12 and/or brake system 16 to provide torque to slow or accelerate the vehicle 10 to maintain the current target speed as a constant speed despite outside forces (e.g., drag, gravity, wind, etc.). In this way, the brake pedal 24 may be additionally or alternatively used as an input device to set target speed.

FIG. 3 is a schematic illustration which includes the brake pedal 24 in the zero, undepressed position. As the driver presses on the brake pedal 22, the vehicle 10 slows and the target speed decreases. In particular, the target speed stored in the controller 18 may be decreased. For example, when the brake pedal 24 returns to the zero (e.g., undepressed) position, the controller 18 may determine the current speed of the vehicle (e.g., via the sensor(s) 26) and store this speed as the current target speed. The controller 18 may then work in conjunction with the drivetrain 12, brake system 16, and/or sensor(s) 26 to maintain the target speed until the acceleration pedal 22 or brake pedal 24 is depressed again.

The control of the target speed stored in the controller 18 may be a function of selected settings. In one embodiment, the target speed is only updated to be the speed of the vehicle 10 when the acceleration pedal 22 or the brake pedal 24 is released. “Release” of a pedal may be the time at which the driver stops applying a force to the pedal or may refer to the time at which the pedal returns to the zero position, or some other selected timing for setting the target speed based on the sensor 26 output.

In other embodiments, the acceleration pedal 22 may act as a proportional input device with the controller 18 continuously updating the target speed while the acceleration pedal or brake pedal is depressed and the vehicle speed being simultaneously matched to the continuously updated target speed. In one example, the percent of maximum travel of the acceleration pedal 22 may equate to a percent of a maximum target speed. In this way, the driver may use the acceleration pedal 22 as a direct selection of target speed based on the degree to which the pedal is depressed.

In another embodiment, the controller 18 may be configured to increase the target speed (e.g., linearly or non-linearly) in accordance with length of time that the acceleration pedal 22 and/or brake pedal 24 is depressed. For example, the target speed may continue to increase as long as the acceleration pedal 22 is continuously held past a threshold point. The controller 18 may similarly slow the vehicle 10 by decreasing the target speed and simultaneously decelerating to match the target speed as long as the brake pedal 24 is depressed past a threshold point. In some embodiments, the rate of change of the target speed may depend on the degree to which the acceleration pedal 22 and/or brake pedal 24 is depressed. For example, if the acceleration pedal 22 is “floored” to its maximum position, the target speed may increase rapidly compared to situations in which the acceleration pedal 22 is more lightly pressed. Similarly, if the brake pedal 24 is depressed to its maximum position, the controller 18 may rapidly decrease the target speed and decelerate the vehicle 10.

Consistent with disclosed embodiments, when the brake pedal 24 is pressed until the car reaches zero speed, the vehicle controls its speed to zero (hill-hold) until the accelerator pedal 22 is pressed again. For example, even though a driver takes their foot off of the brake pedal 24 while stopped on a hill, the vehicle 10 remains stationary because the controller 18 is controlling the vehicle speed to be zero (e.g., by operating the brake system 16 to keep the car from moving).

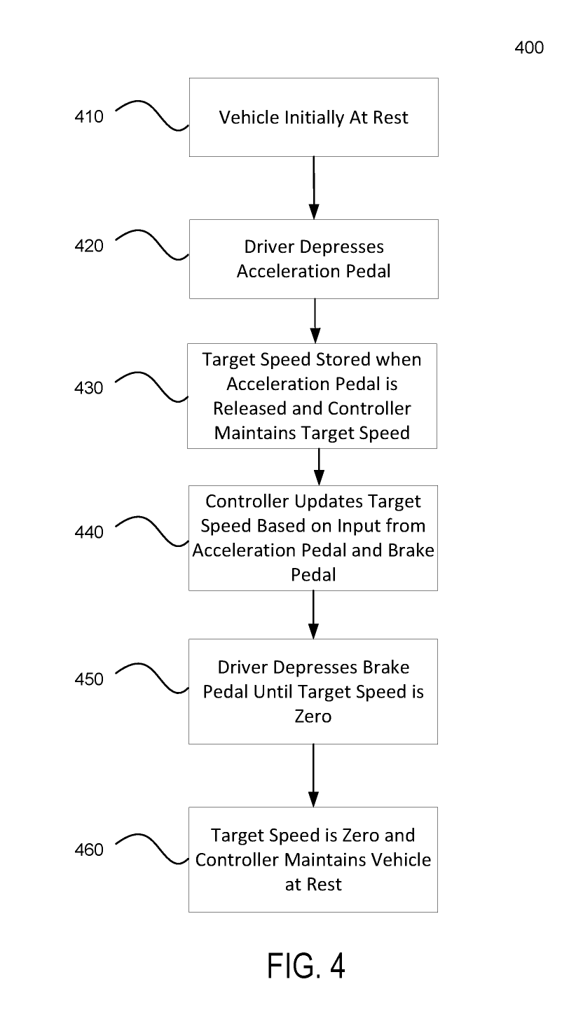

FIG. 4 is a flowchart of an exemplary process 400 which generally describes operation of the vehicle 10 using the disclosed target speed configuration of pedal 22, 24, and controller 18. In step 410, the car is initially at rest. For example, the vehicle 10 is at a stop light. When the driver depresses the acceleration pedal 22 (step 420), the vehicle 10 accelerates. When the driver releases the acceleration pedal 22 and it returns to a zero position, the target speed is set and the controller maintains the vehicle 10 at this speed using the drivetrain 12, braking system 16, and sensor(s) 26 (step 430).

While driving, the driver will inevitably need to adjust the speed of the vehicle 10. The driver can accomplish this by adjusting the target speed stored in the controller 18 by depressing the acceleration pedal 22 or brake pedal 24. Depending on which pedal is depressed, the speed of the vehicle 10 changes due to torque applied by the drivetrain 12 or the braking system 16. Whenever a pedal is released, the target speed is updated (step 440).

Eventually, the driver will need to stop the vehicle 10. In this instance, the driver depresses the brake pedal 24 until the vehicle stops and the controller 18 changes the target speed to zero (step 450). This will cause the vehicle 10 to be back at rest and the controller 18 to maintain the vehicle at a target speed of zero (step 460). This process can be used to control the speed of the vehicle 10.

In an exemplary embodiment, the disclosed acceleration control works in both drive directions: forward and backward. However, the transformation of pedal positions into acceleration or deceleration respectively might be different for reverse driving. The transformation of the pedal position of the acceleration pedal 22 or the brake pedal 24 can be linear or non-linear. In some embodiments, the system may include a switch input for switching between an acceleration control mode in which the vehicle operates according to the acceleration control described herein and a conventional mode in which the vehicle does not maintain speed at the release of a pedal.

The disclosed acceleration control makes the usage of a cruise control stalk unnecessary or replaces it altogether. In the disclosed embodiments, the acceleration and brake pedals act as the cruise control inputs, with the acceleration pedal increasing a target speed and the brake pedal decreasing the target speed. When either pedal is depressed, the car accelerates or decelerates appropriately. When the pedal is released, a new target speed is set with the controller and is thereafter maintained automatically.

Thus, an intuitive control of vehicle speed is provided by the disclosed acceleration control. The system obviates the need for additional cruise control inputs. This advantage allows the driver to leave their hands on the steering wheel while allowing for automated control of a maintained speed. This helps driver comfort, especially on long drives. Moreover, because the maintained speed may be zero, additional hill-holding functionality is unnecessary. The driver does not need to learn how to activate hill-hold by some other process such as double pressing the brake pedal. Additionally, the driver does not need to hold the brake when stopped on a hill.

Having thus described the presently preferred embodiments in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiments and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

What is claimed is:

1. A control system for a vehicle, comprising:
a drivetrain;
a braking system;
a plurality of traction devices configured to accelerate and decelerate the vehicle based on input from the drivetrain and braking system;
an acceleration pedal and a brake pedal configured to be operated by a driver;
one or more sensors configured to produce a signal indicative of a parameter of the vehicle; and
a controller electronically connected to the drivetrain, the braking system, the acceleration pedal, and the brake pedal,
wherein the controller is configured to store a target speed and adjust the target speed based on input from the acceleration pedal, the brake pedal, and the one or more sensors.

2. The control system of claim 1, wherein the controller determines the target speed based on output from the one or more sensors at a time when the acceleration pedal or the brake pedal is released.

3. The control system of claim 2, wherein the output of the one or more sensors is the vehicle speed at the time when the acceleration pedal or the brake pedal is released.

4. The control system of claim 1, wherein the controller increases the target speed based on input from the acceleration pedal.

5. The control system of claim 4, wherein the controller decreases the target speed based on input from the brake pedal.

6. The control system of claim 1, wherein the adjustment of the target speed is based on a degree to which the acceleration pedal or brake pedal is depressed in comparison to a maximum deflection position.

7. The control system of claim 1, wherein the adjustment of the target speed includes the controller continuously updating the target speed while the acceleration pedal and brake pedal are depressed.

8. The control system of claim 7, wherein the adjustment of the target speed is based on a length of time the acceleration pedal or brake pedal is depressed past a threshold position.

9. The control system of claim 7, wherein the adjustment of the target speed is based on both the degree to which the acceleration pedal or brake pedal is depressed in comparison to a maximum deflection position and a length of time the acceleration pedal or brake pedal is depressed past a threshold position.

10. The control system of claim 7, wherein the adjustment of the target speed includes a rate of change, and the rate of change of the target speed depends on the degree to which the acceleration pedal or brake pedal is depressed.

11. The control system of claim 1, wherein the one or more sensors include a speed sensor.

12. The control system of claim 1, wherein the controller is configured to maintain a target speed of zero with the brake pedal in an undepressed position.

13. The control system of claim 12, wherein the controller is configured to maintain the target speed of zero with the brake pedal in the undepressed position and the vehicle on an incline.

14. A method of controlling a speed of a vehicle, the vehicle including traction devices, a controller, a drivetrain, a braking system, a speed sensor, an acceleration pedal, and a brake pedal, the method comprising:
storing a target speed of the vehicle in the controller based on the depression of the acceleration pedal or the brake pedal and an output of the speed sensor; and
maintaining the vehicle at the target speed via the controller by applying a torque to the traction devices using the drivetrain and the braking system.

15. The method of claim 14, wherein the controller stores the target speed based on an output of the speed sensor at a time the acceleration pedal or the brake pedal is released.

16. The method of claim 15, further comprising the controller updating the target speed based on the acceleration pedal or the brake pedal being depressed.

17. The method of claim 16, wherein the controller updates the target speed based on the output of the speed sensor.

18. The method of claim 14, wherein the controller continuously updates the target speed while the acceleration pedal or the brake pedal is depressed.

19. The method of claim 18, wherein the controller simultaneously controls the drivetrain and braking system to match the vehicle speed to the continuously updated target speed.

20. The method of claim 14, wherein the controller maintains the vehicle in a rest position when the target speed is zero.
